(19) United States
(12) Patent Application Publication
(10) Pub. No.: US 2009/0287666 A1
(43) Pub. Date: Nov. 19, 2009

(54) PARTITIONING OF MEASURES OF AN OLAP CUBE USING STATIC AND DYNAMIC CRITERIA

(75) Inventors: Daniel Martin DeKimpe, La Selva Beach, CA (US); Aman Sinha, San Jose, CA (US); David Giddens Wilhite, JR., Saratoga, CA (US)

Correspondence Address: MOLLBORN PATENTS, INC., 2840 COLBY DRIVE, BOULDER, CO, 80305, US

(73) Assignee: INTERNATIONAL BUSINESS MACHINES CORPORATION, Armonk, NY (US)

(21) Appl. No.: 12/119,797

(22) Filed: May 13, 2008

(51) Int. Cl. G06F 7/06; G06F 17/30

(52) U.S. Cl. 707/4; 707/E17.017

(57) ABSTRACT

Methods and apparatus, including computer program products, implementing and using techniques for partitioning measures of an OLAP cube into one or more measure sets. One or more static partitioning criteria are applied to each measure in the OLAP cube. One or more dynamic partitioning criteria are applied to each measure in the OLAP cube. The measures are grouped into measure sets based on the applied static and dynamic partitioning criteria.

### BACKGROUND

This invention relates to database processing. A commonly used technique for analyzing data stored in databases is Online Analytical Processing (OLAP). OLAP can quickly provide answers to analytical queries that are multidimensional in nature, and is therefore commonly used in a wide range of business intelligence applications. Some application examples include business performance management, planning, budgeting, forecasting, financial reporting, analysis, simulation models, knowledge discovery and data warehouse reporting, and so on.

Databases configured for OLAP employ a multi-dimensional data model, allowing for complex analytical and ad-hoc queries with rapid execution time. In the core of any OLAP system is a concept of an OLAP cube, which is sometimes also referred to as a multi-dimensional cube or a hypercube. The OLAP cube includes numeric facts, which are typically referred to as measures, and are derived from the records in a fact table in the database. The measures are categorized by dimensions derived from a dimension table in the database. Sometimes, measures that are expressed using the SQL language are referred to as ‘SQL measures’. The OLAP cube metadata may also contain measures that are expressed using an OLAP specific language, such as MDX. In the remainder of this document, the term ‘measures’ will be used to imply SQL measures only, unless stated otherwise.

In the simple case, a measure may correspond to single aggregation, such as SUM, MIN, MAX and other aggregation functions that are defined over the underlying fact table data. A measure can also be more complex and include more than one aggregation function, where each aggregation is associated with a particular dimension of the cube. Such measures are also known as Asymmetric Measures. For example, an “Inventory measure” can have two aggregations, such as a SUM along a “Product dimension” and a MIN along a “Time dimension.” Furthermore, the aggregations used by both simple and complex measures can be either additive (distributive) or non-additive (non-distributive). In the case of complex (asymmetric) measures, the aggregations can be a combination of distributive and non-distributive aggregations.

An OLAP cube can contain any combination of simple and complex measures. Further, an OLAP query can reference any combination of simple and complex measures. In order to satisfy an OLAP query, a cube server operating in a Relational OLAP (ROLAP) mode can generate one or more SQL statements against the database on which the cube is defined. A cube server can be described as a mid-tier server software that accepts client OLAP queries through established standard protocols, such as ODBO or XMLA, analyzes the queries, and retrieves the relevant measures and dimension data from the underlying database. The cube server also typically embodies a calculation engine, a dimensional metadata cache and a data cache which together are designed to improve the performance of OLAP queries. The cube server may also cache the measure values retrieved from the database in order to improve query performance.

The SQL measures of a cube are typically also classified as ‘base measures’ or ‘derived measures’. Base measures are defined using aggregation expressions over the underlying fact table columns, such as Sales, Quantity, and so on. For example, a Total Sales measure can be defined as some expression around SUM(Sales) where ‘Sales’ is a fact table column. Derived measures are defined on top of existing base measures and do not reference any of the underlying database columns directly. It should be noted that a measure such as SUM(Sales)-SUM(Cost) is also considered a base SQL measure.

The cube server must evaluate the following tradeoff. On the one hand, the cube server should try to minimize the number of round-trips to the database by fetching not only the measures specified in the OLAP query, but also other measures in the cube and cache these measures locally. On the other hand, a naive policy of fetching all measures in a single Structured Query Language (SQL) statement will likely produce poor performance from the database because in many cases the database will be unable to generate an efficient query plan that optimizes computations across all the measures. A bad query plan will nullify the benefits of saving the round-trips to the database. Thus, it is important for the cube server to determine the right balance in terms of which measures can be retrieved together.

### SUMMARY

In general, in one aspect, the invention provides methods and apparatus, including computer program products, implementing and using techniques for partitioning measures of an OLAP cube into one or more measure sets. One or more static partitioning criteria are applied to each measure in the OLAP cube. One or more dynamic partitioning criteria are applied to each measure in the OLAP cube. The measures are grouped into measure sets based on the applied static and dynamic partitioning criteria.

The invention can be implemented to include one or more of the following advantages. The underlying relational database management system (RDBMS) can generate a better query plan for SQL statements, thereby improving the performance of the OLAP query. The cube server has greater flexibility in deciding what subset of measures to cache in order to improve the cache hit ratio, while at the same time getting good performance from the underlying RDBMS on a cache miss. A cube server that has the ability to submit SQL queries in parallel to the RDBMS can start processing the SQL results quicker since the SQL for certain measure sets return sooner compared to others.

The details of one or more embodiments of the invention are set forth in the accompanying drawings and the description below. Other features and advantages of the invention will be apparent from the description and drawings, and from the claims.

### DESCRIPTION OF DRAWINGS

FIG. 1 shows a schematic view of a set of seven base measures, M1 through M7, classified in accordance with one embodiment of the invention.

FIG. 2 shows cubelets and measure sets in accordance with one embodiment of the invention.

Like reference symbols in the various drawings indicate like elements.

### DETAILED DESCRIPTION

### Overview

The various embodiments of the invention described herein pertain to optimization of OLAP queries. In particular, the various embodiments of the invention relate to partitioning the measures of an OLAP cube into sets using both static and dynamic criteria and maintaining statistics associated with the measures, such that a cube server can consider the characteristics of a measure set during caching and SQL generation. As will be discussed below, in various embodiments, measures are not statically bound to a particular measure set, but can be moved from one set to another, for example, based on run-time access patterns, cost considerations, and so on.

Compared to existing methods this partitioning improves the probability that the underlying RDBMS will generate a better query plan for the SQL statements, thereby improving the performance of the OLAP query. As will be discussed in further detail below, the optimizations in accordance with the various embodiments primarily apply to the base measures. However, the derived measures also benefit from these optimizations indirectly since the cost of computing a derived measure is dependent on the cost of computing one or more base measures.

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer-usable program code embodied in the medium. Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, etc.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present invention is described below with reference to block diagrams of methods, apparatus (systems) and computer program products according to embodiments of the invention. It will be understood that each block of the block diagrams, and combinations of blocks in the block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the block diagram block or blocks. The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the block diagram block or blocks.

These computer program instructions can also be stored in a computer-readable medium that can direct a computer or other programmable data processing apparatus to function in a particular manner, such that the instructions stored in the computer-readable medium produce an article of manufacture including instruction means which implement the function/act specified in the block diagram block or blocks.

The computer program instructions can also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the block diagram block or blocks.

### Categorization of Measures

In various embodiments of the invention, measures can be categorized using a hierarchy of categories. At the top of the hierarchy is the dimensionality category. Dimensionality is characterized by two factors: the number of aggregations for the measure and the exact dimensions on which those aggregations are applied. For example, consider a cube with 10 dimensions. A simple measure with dimensionality D1 has the SUM aggregation function along all 10 dimensions. A measure with dimensionality D2 may have COUNT aggregation along dimensions 1-9 and MAX on dimension 10. Further, a measure with dimensionality D3 may have MAX aggregation on dimension 1 and COUNT on dimensions 2-10.

Next, the measures are categorized as Distributive or Non-Distributive. For distributive measures, aggregations at a higher level of granularity can be computed from the immediate child level. For non-distributive measures, aggregations generally must be computed using leaf level granularity. Such computations are significantly more expensive compared to the distributive measure computations. In some embodiments, the classification of the distributiveness of a measure is based on the knowledge of the capability of the underlying RDBMS. Certain measures can be distributive on one RDBMS, but be non-distributive on another RDBMS. This information can easily be maintained in a file or a table from which the information can be referenced by the cube server during run-time. In some embodiments, if all aggregation functions within a measure are distributive, then the measure is considered distributive. On the other hand, if a complex measure has a combination of distributive and non-distributive aggregations, the complex measure can be classified under both categories. The SQL generated for complex measures generally includes one or more subqueries. Examples of such complex measures can be found, for example, in U.S. Patent Publication No. 2004/0215626, which is incorporated herein by reference in its entirety. In some embodiments, the underlying RDBMS can use specialized distributive aggregates to answer one or more subquery, while other (non-distributive) portions of the query get processed separately.

In some embodiments, a third level of categorization is based on dynamic criteria. One example of the dynamic criteria is whether the underlying RDBMS will route the query to a Materialized Query Table (MQT) (or aggregate table/materialized view). This information can be dynamically obtained through an Explain feature supported by most RDBMSs. Another example of such criteria is the optimizer estimated cost of processing the query. Based on the criteria, the measures can be further partitioned into sets, such that potentially ‘high-cost’ measures are kept in a separate set from the ‘low-cost’ measures. It will be described in further detail below how the cost of computing a measure is affected depending on what “slices” of the cube are covered by an underlying MQT in the database. However, it should be realized that MQTs are just one aspect of the factors that affect performance of computing the measure. The presence of appropriate indexes, the partitioning of data (for example in a distributed environment), the amount of sort heap available and other configuration parameters could also affect the overall cost.

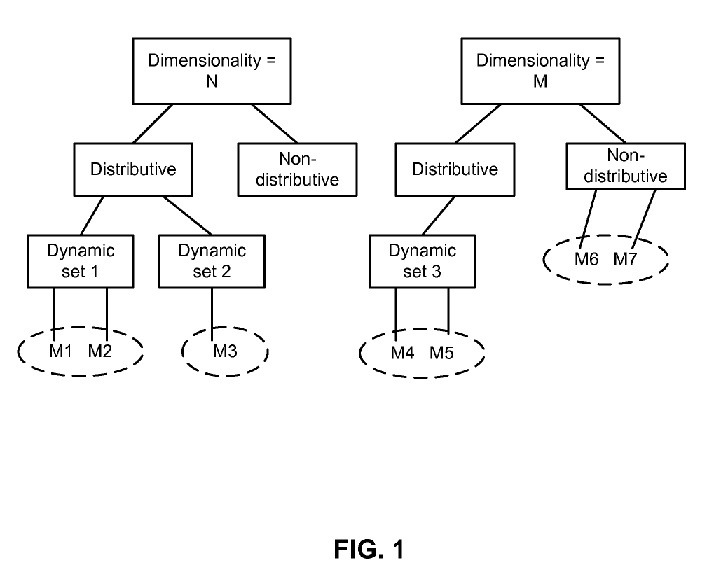

FIG. 1 shows an example of a set of seven base measures, M1 through M7, classified into the categories described above. As can be seen in FIG. 1, measure M1 and M2 have the same dimensionality (N) and they are both distributive. In addition, they both fit in the same set based on certain dynamic criteria. Measure M3 is also distributive but belongs to a different set based on the dynamic criteria. Measures M4 and M5 have a different dimensionality (M) and they are both distributive. Finally, measures M6 and M7 are non-distributive measures. As will be discussed in further detail below, measures that belong to the same set can be retrieved using a single SQL statement.

In theory, dynamic criteria can be applied to any cube measure regardless of whether the measure is distributive or non distributive. Thus, if there are two measures that map to underlying SQL aggregation functions STDDEV and COUNT D1STINCT which are both non-distributive, it is possible that at run-time the estimated cost of computing STDDEV is substantially higher than the cost of computing COUNT D1STINCT, in which case the measures can potentially be kept in separate sets. As is well known to those of ordinary skill in the art, RDBMS systems have different ways of optimizing certain aggregation functions, and the cost estimates can vary accordingly.

Table 1 shows four different OLAP queries (numbered Query 1 through Query 4), the number of SQLs generated based on the methods described above, and the possible RDBMS impact. The measures referenced in Table 1 are the same measures that are illustrated in FIG. 1.

TABLE 1
Characteristics of OLAP and SQL queries with respect to Measures

| | Measures | | |
|---|---|---|---|
| OLAP query | referenced | Number of SQLs | RDBMS impact |
| Query 1 | M1, M2 | 1 SQL that fetches both M1 | Can potentially generate |
| | | and M2 | more efficient query |
| | | | plan (for instance |
| | | | exploiting MQTs) |
| Query 2 | M1, M3 | 2 SQLs: first SQL fetches | Can likely optimize the |
| | | both M1 and M2, second | first SQL or potentially |
| | | SQL fetches M3 | both SQLs. Even if one |
| | | | of the SQLs gets good |
| | | | performance, it is useful |
| | | | to the cube server |
| | | | especially in scenarios |
| | | | where parallel SQL |
| | | | generation occurs. The |
| | | | cube server can start |
| | | | processing the results of |
| | | | the first SQL without |
| | | | waiting for the second |
| | | | SQL to complete. |
| Query 3 | M1, M2, M4, | 2 SQLs: first SQL fetches | Can likely optimize the |
| | M5 | M1 and M2, second fetches | first SQL or potentially |
| | | M4 and M5 | both SQLs. |
| Query 4 | M6, M7 | 1 SQL that fetches both M6 | Since both measures are |
| | | and M7 | non-distributive, this query |
| | | | might possibly |
| | | | perform poorly. |

### Re-Classifying Measures Based on Run-Time Statistics

As was discussed above, in some embodiments, it is possible to re-classify the measures based on run-time statistics. The cube server's cache manager, for example, can maintain a cost of computing a measure, and a reference count for a measure, the latter indicating the usage pattern of a measure.

The cost of computing a measure is closely related to the database optimizer's estimate of computing the measure and does not depend on the OLAP queries themselves. The cost of computing the measure will be discussed in further detail below in the section ‘Cubelets, Slices and Measure Sets’.

A reference count keeps track of how many OLAP queries actually reference a measure over the course of a certain time, referred to as an ‘evaluation interval’. For practical purposes, the evaluation interval can be either the same as the cube refresh time interval or be a separately configurable parameter. For example, during this interval, if 100 queries references M1 and M2, and 20 queries references M3, then these values would be recorded as the reference counts, show in Table 2.

TABLE 2
Statistics related to a measure

| | Cost (based | |
|---|---|---|
| | on a cost | Reference |
| Measure | function) | count |
| M1 | C1 | 100 |
| M2 | C2 | 100 |
| M3 | C3 | 20 |

The reference count of the measure reflects the usage pattern of the measure since the reference count tracks the frequency of usage of the measure across several OLAP queries. However, some cube models can have a large number of measures but only a small percentage of the measures may be referenced by queries. For instance, if a cube models has 33 measures, it would clearly be quite costly in both space and time to fetch all of the measures, compared to fetching only a subset of the measures.

In some embodiments, the cube server's cache manager analyzes the (Reference Count)/Cost ratio at the end of every evaluation interval to decide whether the measure should continue to belong to the same measure set or be reclassified under a different measure set. Reclassifying a measure has an effect on both the cache manager and the SQL generation layer which must take into account the new composition of a measure set. However, it should be noted that the change in classification only affects tuples that are not already cached (either because they were never cached before, or because they have been evicted by the cache manager). Any existing tuples in the cache continue to be used to answer OLAP queries.

It should be noted that the reference count of the cube measures is tracked by the cube's cache manager on an entire cube basis, not on a per ‘cubelet’ basis. The reference count only depends on the number of times a cube measure is referenced by OLAP queries. In fact, in general, there is no need to track the reference count on a per cubelet basis because the cube measures are common to all cubelets and the cube's cache manager has global knowledge of the reference count of these measures. The proposed solution only depends on this global knowledge.

It should be noted that other interesting metrics can also be included in the statistics for a measure. For example, such metrics can include calculating a weighted importance metric that factors how recently measures were accessed as well as the count. A measure that has been referenced 50 times in the last five minutes might be more important than a measure referenced 200 times but not in the last ten hours. This is similar to an LRU-K policy used in caching subsystems of databases.

### Additional Optimizations

Measures within a set are inherently correlated. In some embodiments, it may also be possible to correlate different measure sets. For example, in the example in Table 1, the cube server can keep track of the correlations among the measure sets as shown in Table 3, where set 1 and set 2 have strong correlations and set 3 is only weakly correlated or not correlated at all with set 1 and set 2. For instance, if most queries that contain measures M1 and M2 also reference measures M4 and M5, then the cube server can decide to fetch both measure sets at the same time using two separate SQL statements. The advantage of doing this is that if the sequence of execution of the OLAP queries is Query 1, followed by Query 3 at a later time, then Query 3 will have its measures already cached, thus saving the round-trip to the database.

TABLE 3
Correlation count among measure sets

| | Set 1 | Set 2 | Set 3 |
|---|---|---|---|
| Set 1 | — | 10 | 0 |
| Set 2 | 10 | — | 2 |
| Set 3 | 0 | 2 | — |

Some embodiments allow a hybrid approach where a measure need not be exclusive to a single measure set. Instead, depending on the usage pattern, it may be necessary to have the same measure appear in more than one measure set. For example, a small measure set with measures M1 and M2 that are high priority and another measure set with measures M1 through M7. The first measure set could represent only distributive measures while the second measure set can represent both distributive and non-distributive measures. While evaluating the hybrid approach, a cost/benefit analysis must be done to determine if the benefit of maintaining the measure in more than one measure set outweighs the extra storage cost associated with such maintenance. For example, if an OLAP query references only distributive measures, then it would be desirable for the SQL query to include only distributive measures, as this will maximize the odds of matching an MQT. On the other hand, if the OLAP query references non-distributive measures only, the odds of matching an MQT is less likely. Thus, in such a situation, it might make sense for the SQL statement to request both distributive and non-distributive measures, since extra processing for getting all measures at the same time is likely small compared to potentially issuing an extra SQL later if the distributed measures need to be requested.

### Warm Versus Cold Cache Behavior

As the skilled reader realizes, the proposed solution is most useful when the cube server's cache hit ratio is in the range of low to medium, i.e. in the ‘cool’ cache scenarios rather than the warm cache scenarios. The optimizations of batching measures into sets and determining which measures to batch together during retrieval from the database is only relevant when there is a cache miss. In many OLAP analytics environment, since the queries are ad-hoc, there can be substantial number of cache misses and the solution proposed here would be quite useful. Also, consider a scenario where the cube data must be frequently updated to reflect the latest measures values from the database. In such scenarios, the performance of the cube server is dominated by the cold-cache performance and again the proposed optimizations would be effective.

### Cubelets, Slices and Measure Sets

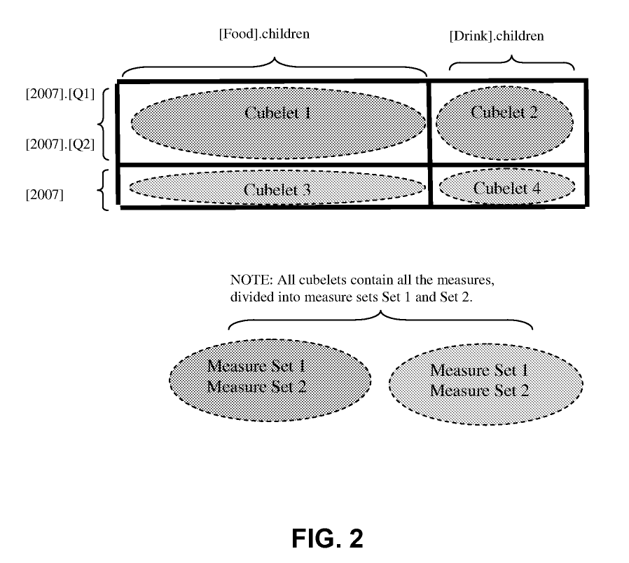

The embodiments described above can be further illustrated by an example that is based on an existing cube server architecture, and with reference to FIG. 2. In the example below, the term ‘cubelet’ refers to a group of cells in the OLAP cube such that these cells belong to the same level of granularity in the dimensions that make up the cell. Additional information about cubelets and their properties can be found in, for example, U.S. Pat. No. 6,694,322, which is incorporated herein in its entirety. For example, as can be seen in FIG. 2, the cubelet 1 refers to all the cells which represent the children of ‘Food’ (which is at the ‘Product Category’ level in the Product hierarchy) and the first two quarters of ‘2007’ (which is at the ‘Year’ level in the Time hierarchy). It should be noted that a cubelet is identified by the parent member's level of granularity.

It should be noted that the cubelets differ mainly in terms of the dimension members that qualify the cubelet. The cube measures are common among the cubelets. Thus, all cubelets store the same set of cube measures. The term ‘slice’ will be used herein to refer to the level of granularity represented by a cubelet. In the example above, cubelet 1 and cubelet 2 are both represented by the slice {Product Category, Year}. Cubelet 3 and cubelet 4 are represented by the slice {Product Category, All Time}.

In the cube server, the retrievals for cubelet 1 and cubelet 2 are combined into a single SQL statement. Similarly, the retrievals for cubelet 3 and cubelet 4 are combined into a single SQL statement since these cubelets are grouped into the same ‘slice’.

Regardless of how the cubelets are combined, the existing method in the cube server will generate a SQL statement that would typically retrieve all the measures associated with the cubelet. Assume that the MQT in the database only covers the measures in Measure Set 1. In this scenario, clearly combining all the measures of a cubelet into a single SQL could be counter-productive especially if the OLAP query is only requesting the cube measures defined in Measure Set 1.

In accordance with various embodiments of the invention, the cube's cache manager maintains statistics associated with each Cube measure in the context of the slices that have been requested by the OLAP queries so far. Although the number of cubelets in the cache can be fairly large, the number of slices associated with the cubelets is substantially smaller because several cubelets get grouped into a slice. Further, the cache manager does not track all possible slices in the cube. The cache manager only tracks slices that have been referenced by the queries during a particular evaluation interval. The storage overhead of maintaining these statistics is expected to be small. Table 4 shows the estimated cost of computing a Cube measure.

TABLE 4
Slices, cubelets and estimated cost of computing cube measures

| | | Estimated Cost of computing a Cube | | | |
|---|---|---|---|---|---|
| | | Measure (depending on the Slice) | | | |
| Slice | Cubelets | M1 | M2 | M3 | M4 |
| Slice A | Cubelet 1, | C1A | C2A | C3A | C4A |
| | Cubelet 2 | | | | |
| Slice B | Cubelet 3, | C1B | C2B | C3B | C4B |
| | Cubelet 4 | | | | |
| Average | | C1_Avg | C2_Avg | C3_Avg | C4_Avg |
| Cost | | | | | |

In this example, it is assumed that the database contains an MQT that covers the Slices A and B, but only contains the SQL aggregation expressions that cover the Cube measures M1 and M2 (that is, not M3 and M4).

The estimated cost of computing the Cube measures M3 and M4 is likely to be substantially higher. The estimated cost is averaged across all existing slices and the lower cost measures (in this case M1 and M2) are grouped in one measure set, while the higher cost measures (M3 and M4) are grouped in a separate measure set. This enables the cube's cache manager to only generate the SQL statement for the lower cost measures if they are the ones referenced in an OLAP query. If both lower and higher cost measures are referenced, then separate SQL statements can be executed.

The block diagrams in the figures illustrate the architecture, functionality, and operation of possible implementations of systems, methods and computer program products according to various embodiments of the present invention. In this regard, each block in the block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams, and combinations of blocks in the block diagrams, can be implemented by special purpose hardware-based systems that perform the specified functions or acts, or combinations of special purpose hardware and computer instructions.

A number of embodiments of the invention have been described. Nevertheless, it will be understood that various modifications may be made without departing from the spirit and scope of the invention. Accordingly, other embodiments are within the scope of the following claims.

1. A computer-implemented method for partitioning measures of an OLAP cube into one or more measure sets, the method comprising:
applying one or more static partitioning criteria to each measure in the OLAP cube;
applying one or more dynamic partitioning criteria to each measure in the OLAP cube; and
grouping the measures into measure sets based on the applied static and dynamic partitioning criteria.

2. The method of claim 1, wherein applying one or more static partitioning criteria includes:
categorizing measures using a hierarchy of categories.

3. The method of claim 2, wherein the hierarchy of categories includes a dimensionality category and a distributiveness category.

4. The method of claim 3, wherein the distributiveness category includes a category for distributive measures and a category for non-distributive measures.

5. The method of claim 1, wherein applying one or more dynamic partitioning criteria includes:
determining an estimated cost of processing a query referencing one or more measures;
partitioning the one or more measures based on the estimated cost.

6. The method of claim 1, wherein applying one or more dynamic partitioning criteria includes:
determining a reference count for one or more measures;
partitioning the one or more measures based on the reference count.

7. The method of claim 1, further comprising:
retrieving one or more measures from a database, wherein the measures in a single measure set are retrieved using a single structured query language statement.

8. The method of claim 1, further comprising:
regrouping measures into different measure sets based on runtime statistics.

9. The method of claim 1, further comprising:
determining a correlation between measure sets; and
grouping correlated measure sets into groups of measure sets.

10. The method of claim 1, wherein a single measure is assigned to more than one measure set.

11. A computer program product for partitioning measures of an OLAP cube into one or more measure sets, the computer program product comprising:
a computer usable medium having computer usable program code embodied therewith, the computer usable program code comprising:
computer usable program code configured to apply one or more static partitioning criteria to each measure in the OLAP cube;
computer usable program code configured to apply one or more dynamic partitioning criteria to each measure in the OLAP cube; and
computer usable program code configured to group the measures into measure sets based on the applied static and dynamic partitioning criteria.

12. The computer program product of claim 11, wherein the computer usable program code configured to apply one or more static partitioning criteria includes:
computer usable program code configured to categorize measures using a hierarchy of categories.

13. The computer program product of claim 12, wherein the hierarchy of categories includes a dimensionality category and a distributiveness category.

14. The computer program product of claim 13, wherein the distributiveness category includes a category for distributive measures and a category for non-distributive measures.

15. The computer program product of claim 11, wherein the computer usable program code configured to apply one or more dynamic partitioning criteria includes:
computer usable program code configured to determine an estimated cost of processing a query referencing one or more measures;
computer usable program code configured to partition the one or more measures based on the estimated cost.

16. The computer program product of claim 11, wherein the computer usable program code configured to apply one or more dynamic partitioning criteria includes:
computer usable program code configured to determine a reference count for one or more measures;
computer usable program code configured to partition the one or more measures based on the reference count.

17. The computer program product of claim 11, further comprising:
computer usable program code configured to retrieve one or more measures from a database, wherein the measures in a single measure set are retrieved using a single structured query language statement.

18. The computer program product of claim 11, further comprising:
computer usable program code configured to regroup measures into different measure sets based on runtime statistics.

19. The computer program product of claim 11, further comprising:
computer usable program code configured to determine a correlation between measure sets; and
computer usable program code configured to group correlated measure sets into groups of measure sets.

20. A system for partitioning measures of an OLAP cube into one or more measure sets, comprising:
a processor, the processor executing a computer program comprising instructions for:
applying one or more static partitioning criteria to each measure in the OLAP cube;
applying one or more dynamic partitioning criteria to each measure in the OLAP cube; and
grouping the measures into measure sets based on the applied static and dynamic partitioning criteria.
